(19) United States
(12) Patent Application Publication
(10) Pub. No.: US 2006/0203258 A1
(43) Pub. Date: Sep. 14, 2006

(54) File management apparatus

(75) Inventors: Noriyuki Komamura, Mishima-shi (JP); Nobuhiro Shimogori, Kawasaki-shi (JP); Seiya Shimizu, Numazu-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/077,820

(22) Filed: Mar. 10, 2005

(51) Int. Cl. G06F 3/12

(52) U.S. Cl. 358/1.1

(57) ABSTRACT

A plurality of documents are stored and managed in a document storage and management section, and a print command is issued from a print command section regardless of a monochrome or a color through an application program for starting up a target document from the documents, each of which is stored in the document storage and management section

### BACKGROUND OF THE INVENTION

1. Field of the Invention

The present invention relates to a file management apparatus which stores and manages a plurality of documents.

2. Description of the Related Art

Jpn. Pat. Appln. KOKAI Publication No. 5-54081 discloses that each item of information is sorted from the most recent final search date; sequential search and display are made in order of such sorting; and the search is cancelled at a time point at which a target image has been displayed.

### BRIEF SUMMARY OF THE INVENTION

According to a primary aspect of the present invention, there is provided a file management apparatus comprising:

a document storage and management section which stores and manages a plurality of documents; and

a print command section which issues a print command regardless of a monochrome or a color through an application program which starts up a target document from among the documents, each of which is stored in the document storage and management section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram depicting a configuration of an embodiment of a file management apparatus according to the present invention;

FIG. 2 is a view showing an example of a configuration of a mouse in the same apparatus;

FIG. 3 is a view showing a display example of a document search screen displayed on a display device in the same apparatus;

FIG. 4 is a view showing a relationship between a file managed in the same apparatus and an image displayed in an image display area;

FIG. 5 is a view showing an example of a configuration of a first file management table in the same file;

FIG. 6 is a view showing an example of a configuration of a second file management table in the same apparatus;

FIG. 7 is a view showing an example of a configuration of a document management table in the same apparatus;

FIG. 8 is a view showing an example of a configuration of the document management table in the same apparatus;

FIG. 9 is a view showing an example of a configuration of the document management table in the same apparatus in the case where an image generating process has completed;

FIG. 10 is a view showing an example of a configuration of a color management table in the same apparatus;

FIG. 11 is a functional block diagram of a CPU having a print command section in the same apparatus;

FIG. 12 is a flow chart for explaining a process for registering document management information in the same apparatus;

FIG. 13 is a flow chart for explaining a process for generating an image of a file in the same apparatus;

FIG. 14 is a flow chart for explaining a process for displaying a document search screen in the same apparatus;

FIG. 15 is a flow chart for explaining a process for generating a document map in the same apparatus;

FIG. 16 is a flow chart for explaining a process for making a search for a document in the same apparatus;

FIG. 17 is a flow chart for explaining the process for making a search for a document in the same apparatus;

FIG. 18 is a flow chart for explaining the process for making a search for a document in the same apparatus; and

FIG. 19 is a flow chart showing a print command instructing process in the same apparatus.

### DETAILED DESCRIPTION OF THE INVENTION

Hereinafter, embodiments of the present invention will be described with reference to the accompanying drawings.

FIG. 1 is a block diagram schematically depicting an example of a configuration of a file management apparatus 1. The file management apparatus 1 is composed of a personal computer (PC) connected to an image input/output device 2, and the like. The image input/output device 2 may be any device as long as it provides an image to the file management apparatus 1 which serves as a PC. For example, the image input/output device 2 is presumed to serve as a scanner, a digital composite machine (multi-functional peripheral: MFP) which comprises the scanner, a digital camera, a computer on a network (for example, WWW server) or the like.

The file management apparatus 1 has a CPU 11, a RAM 12, a ROM 13, an image input interface (I/F) 14, a hard disk drive (HDD) 15, a display device driver 16, a display device 17, a mouse drier 18, a mouse 19, a keyboard interface (I/F) 20, a keyboard 21, and the like.

The CPU 11 controls a whole operation of the file management apparatus 1. The CPU 11 supports a variety of functions by executing a control program stored in the ROM 13 or an application program stored in the HDD 15. The RAM 12 temporarily stores work data or the like. The ROM 13 stores in advance a basic control program or the like required for the file management apparatus 1 to operate. The ROM 13 is provided as a nonvolatile memory.

The image input interface 14 inputs data such as an image from an external device. For example, the image input interface 14 acquires an image from the image input/output device 2. Although FIG. 1 illustrates one image input interface 14, the file management apparatus 1 may be arranged so that a plurality of image input interfaces 14 are provided.

The HDD 15 is provided as a storage device composed of a magnetic disk or the like. The HDD 15 stores a variety of data in a file format. Namely, the HDD 15 stores as a file the data which configures a document targeted to be managed by the file management apparatus 1.

A first file management table 23, a second file management table 24, a document management table 25, a color management table 26 and the like, which serve as data tables, are formed in the HDD 15.

The first file management table 23 and the second file management table 24 each store management information (file management information) relating to a file of data which configures a document targeted to be managed.

The document management table 25 stores management information (document management information) relating to a document targeted to be managed.

The color management table 26 stores information (color management information) relating to a color associated with a document targeted to be managed. Each of the data tables 23 to 26 will be described later in detail.

The HDD 15 stores an application program (document management program) 27 and setting information 28 for functioning at least a PC as the file management apparatus 1.

The document management program 27 has a program which causes a PC to execute a various of processes such as a process for registering document management information; a process for generating an image; a process for displaying a document search screen; a process for generating a document map; a process for making a search for a document; and a process for instructing a print command which are described later. That is, by executing a document management program 27, the PC supports a various of functions such as: a function for registering document management information; a function for generating an image; a function for displaying a document search screen; a function for generating a document map; a function for making a search for a document; and a function for issuing a print command.

The display device driver 16 has a driver circuit which controls the contents displayed by the display device 17, and the like. The display device driver 16 functions as an interface which outputs to the display device 17 a signal of an image to be displayed on the display device 17.

The mouse driver 18 has a circuit which senses information inputted to the mouse 19, and the like. The mouse driver 18 senses movement of the mouse 19, input to a button provided at the mouse 19, or a rotation quantity of a wheel provided at the mouse 19. The mouse driver 18 notifies the CPU 11 of a signal indicating the movement of the mouse 19, input to the button of the mouse 19, or the rotation quantity of the wheel of the mouse 19.

The keyboard interface 20 senses the information inputted to the keyboard 21, and notifies CPU 11 of the inputted information. The keyboard 21 has a plurality of keys such as characters, numerals, or symbols. The input to each key of the keyboard 21 is sensed by the keyboard interface 20, and the sensed input is notified to the CPU 11 as a signal indicating the inputted key.

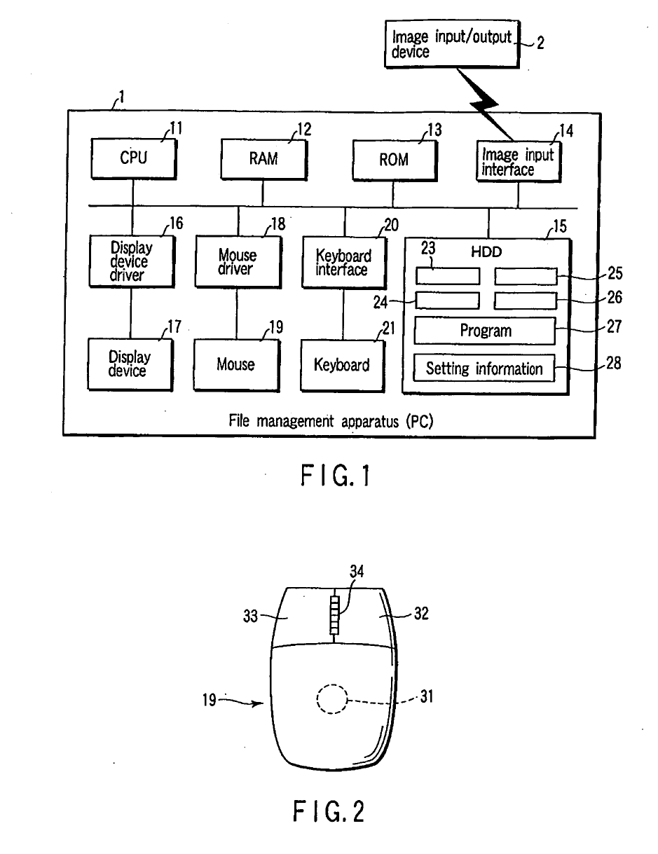

FIG. 2 shows an example of a configuration of the mouse 19. The mouse 19 has an operating sensing mechanism 31, a right button 32, a left button 33, a wheel 34, and the like. The mouse 19 is placed and operated on a plane in a state shown in the figure. The mouse 19 is held by a user's hand. The user moves the mouse 19 on a plane in the state shown in FIG. 2, and operates the right button 32, the left button 33, and the wheel 34 as required.

The operation sensing mechanism 31 converts the movement of the mouse 19 on the plane in to a signal. For example, the operation sensing mechanism 31 has a ball body which rotates in response to the movement of the mouse 19, and a mechanism which converts the movement of the ball body into a signal. The operating sensing mechanism 31 may have: an optical sensor which senses the movement of the mouse 19 on the plane, and a mechanism which converts into a signal the movement of the mouse 19 sensed by the optical sensor.

The operation sensing mechanism 31 is provided at a side which comes into contact with the plane in the state shown in FIG. 2. That is, when the user moves the mouse 19 held in the state shown in FIG. 2, the operation sensing mechanism 31 senses the movement of the mouse 19 on the plane. A signal indicating the movement of the mouse sensed by the operation sensing mechanism 31 is outputted to the mouse driver 18.

The right button 32 is provided at the right side of a main body of the mouse 19 in the state shown in FIG. 2. The right button 32 is operated by the user's second finger or third finger in the case where the user holds the main body of the mouse 19 in the state shown in FIG. 2, for example, by the right hand.

The left button 33 is provided at the left side of the main body of the mouse 19 in the state shown in FIG. 2. The left button 33 is operated by the user's third finger or fourth finger in the case where the user holds the main body of the mouse 19 in the state shown in FIG. 2, for example, by the right hand.

The wheel 34 is a rotary member provided in the vicinity of the center part of the mouse 19 in the state shown in FIG. 2. In the example shown in FIG. 2, the wheel 34 is provided between the right button 32 and the left button. For example, the wheel 34 is operated by the second finger, third finger, or fourth finger of the user who holds the main body of the mouse 19 in the state shown in FIG. 2.

The wheel 34 is installed so as to rotate in a predetermined direction only. In the example shown in FIG. 2, the wheel 34 rotates in a direction from the frontal side to the depth (in a direction from the bottom to the top shown in FIG. 2) and vice verse (in a direction from the top to the bottom shown in FIG. 2). In the following description, with respect to the rotation direction of the above wheel 34, a rotation direction from the frontal side to the depth (from the bottom to the top shown in FIG. 2) is defined as a forward direction, and a rotation direction from the depth to the frontal side (from the bottom to the top shown in FIG. 2) is defined as a backward direction.

The wheel 34 may function as a button. In this case, in the wheel 34, specific input is made by pressing down the wheel 34 itself. The wheel 34 may be pressed down to the right or left, thereby enabling specific input.

Now, a description will be given with respect to a document display screen (document search screen) managed by the file management apparatus 1.

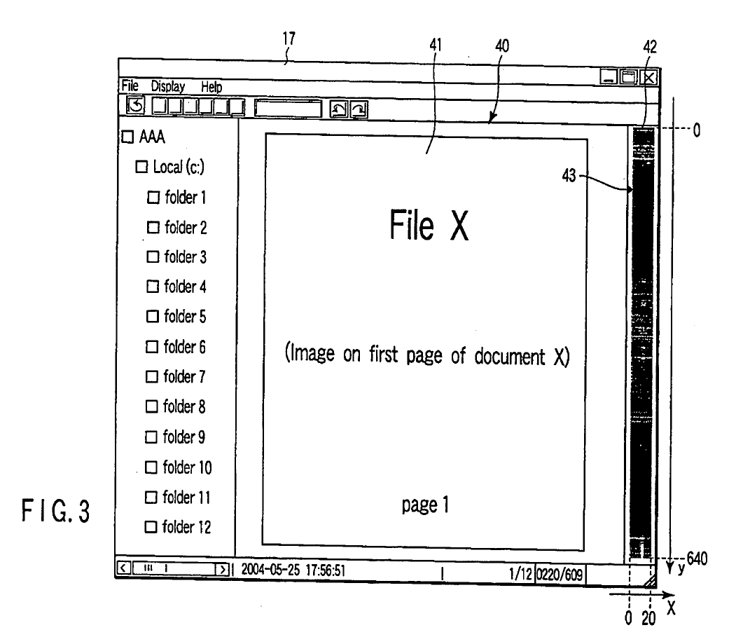

FIG. 3 shows a display example of a document search screen (document display screen) 40 displayed on the display device 17 of the file management apparatus 1.

The file management apparatus 1 displays the document search screen 40 on a display window displayed on the display device 17. The file management apparatus 1 displays on the document search screen 40, as shown in FIG. 3, an image of each page which configures a document managed according to the user operation in units of pages. By referring to the image displayed on the document search screen 40, the user makes a search for a desired document.

The document search screen 40 displays an image display area 41, a document map (search bar) 42, an arrow 43 and the like as well as a tool bar including a variety of operating keys.

The image display area 41 is situated at a substantial center of a display window serving as the document search screen 40 displayed on the display device 17. On the image display area 41, images of one or a plurality of pages configuring a document according to the user operation are displayed in units of pages.

The document map 42 is displayed in an area at a right end of the document search screen 40. The document map 42 is displayed by superimposing in order of time series, the bars (lines) indicating the documents, each of which is managed by the file management apparatus 1. A top bar in the document map 42 shown in FIG. 3 indicates a document having the latest documentation time (the latest document). A bottom bar indicates a document having the oldest documentation time (the oldest document). Namely, in the document map 42 shown in FIG. 3, the bars, each of which is superimposed, indicate newer documents as they go up, and indicate older documents as they go down.

The arrow 43 is displayed in an area adjacent to the document map 42 in the document search screen 40. The arrow 43 indicates a position of a bar which indicates a document being displayed in the image display area 41 on the document map 42.

Each bar of the document map 42 is displayed by the color associated with each document. The color of each bar is set, for example, for each folder which stores a file of data which configures a document. In this case, documents whose data are stored in the same folder are displayed by the same color. Documents whose data are stored in different folders are displayed by the different colors.

In this manner, the user can recognize intuitively the folder in which each document is stored, by the color displayed on the document map 42. The color of the bar which corresponds to each document displayed on the document map 42 may be set for each application for opening the extent or document of a file serving as a document.

Now, a description will be given with respect to change of an image displayed in the image display area 41 of the document search screen 40.

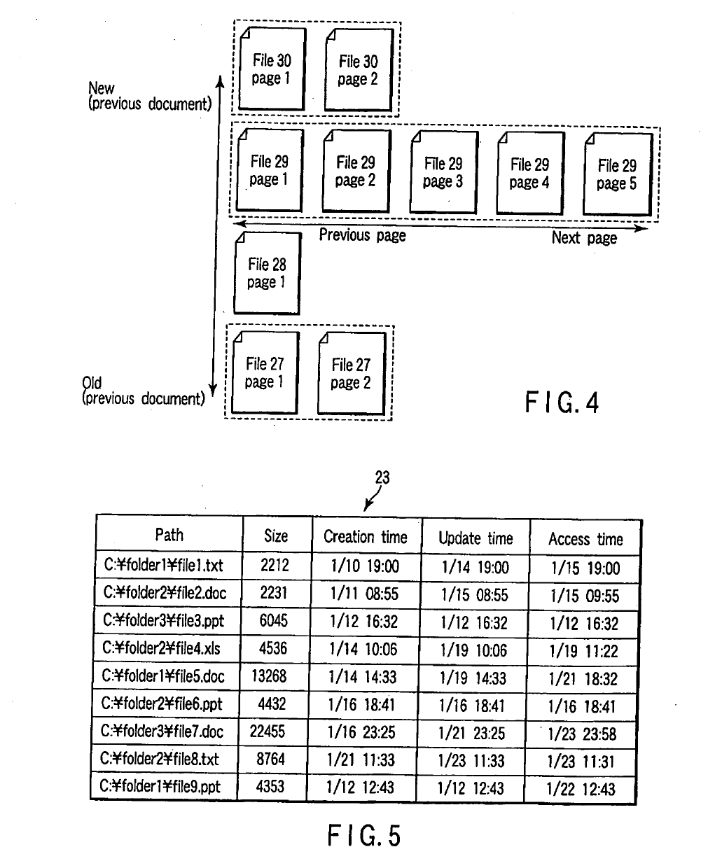

FIG. 4 shows a relationship between a document managed by the file management apparatus 1 and an image displayed in the image display area 41. Each document managed by the file management apparatus 1 consists of one or a plurality of pages. The image displayed in the image display area 41 of the document search screen 40 as shown in FIG. 3 is changed according to the input to the mouse 19 or keyboard 21. The change of the image displayed in the image display area 41 includes a document change or a page change.

The file management apparatus 1, as shown in FIG. 4, manages a plurality of documents based on a documentation time such as a document creation time or an update time. The sequence of such documents is reflected in order of displaying the bars which correspond to the documents, each of which is displayed to be superimposed on the document map 42. Therefore, on the document map 42, the bars corresponding to the documents each are displayed to be superimposed in order of time series as shown in FIG. 3.

The file management apparatus 1 manages a plurality of pages in each document in order of pages as shown in FIG. 4.

The file management apparatus 1 changes a document displayed on the document search screen 40 according to an operation in a longitudinal direction to the mouse 19 or keyboard 21 (vertical direction of FIG. 3). The file management apparatus 1 changes a page displayed on the document search screen 40 according to an operation in a transverse direction (horizontal direction of FIG. 3) to the mouse 19 or keyboard 21.

That is, in the case where the user has made the operation in the longitudinal direction by the mouse 19, the keyboard 21 or the like, the file management apparatus 1 changes the document displayed in the image display area 41 of the document search screen 40. As a result, a typical image of the document changed according to the user's operation in the longitudinal direction (for example, an image on a first page of the document) is displayed in the image display area 41 of the document search screen 40.

In the case where the user has made the operation in the transverse direction by the mouse 19, the keyboard 21 or the like, the file management apparatus 1 changes the document displayed in the image display area 41 of the document search screen 40. As a result, an image of the page changed according to the user's operation in the transverse direction is displayed in the image display area 41 of the document search screen 40.

A description will be given with respect to a case in which the image displayed in the image display area 41 of the document search screen 40 is changed in units of documents.

The change of the document is made in such a manner that the user instructs the change of the document by using an input device such as the mouse 19 or keyboard 21. Here, as described above, the document serving as the image displayed in the image display area 41 is changed, for example, according to the operation in the longitudinal direction (vertical direction). For example, the document is changed according to the input to the upward and downward cursor key (up key and down key) of the keyboard 21 or the operation in the longitudinal direction using a pointing device such as the mouse 19. In the present embodiment, it is assumed that a document is changed according to rotation of the wheel 34 of the mouse 19. A process for changing a document by using the wheel 34 of the mouse 19 will be described later in detail.

In the case where the document has been changed, an image on a first page serving as a typical image of the document is displayed in the image display area 41 of the document search screen 40. Namely, every time the document is changed by using the mouse 19, the keyboard 21 or the like, the image on the first page of each document is sequentially displayed in the image display area 41. For the typical image of each document, a specific page may be set as a typical image from each page.

That is, in the case of changing the typical image (the image on the first page) of the document displayed in the image display area 41, the user instructs the change of the document by using an input device such as the mouse 19 or keyboard 21. In this manner, the file management apparatus 1 sequentially changes the image on the first page of each document displayed in the image display area 41 in order of time series of each document.

Now, a description will be given with respect to a case of changing in units of pages the images displayed in the image display area 41 of the document search screen 40.

The change of the page is made in such a manner that the user instructs the change of the page by using an input device such as the mouse 19 or keyboard 21. Here, as described above, the page serving as the image displayed in the image display area 41 is changed according to the operation in the transverse direction. For example, each page is changed according to the input to the left and right cursor keys (right key and left key) on the keyboard.

Every time a page is changed, the images on the pages, each of which configures a document being displayed, are sequentially displayed in the image display area 41 of the document search screen 40. That is, in the case where a specific page in a specific document is displayed in the image display area 41, the user first displays an image on the first page of a desired document in the image display area 41 by changing the above-described document. In such a display mode, the user instructs the change of the page by using the mouse 19, the keyboard 21 or the like. The file management apparatus 1 having received a page change instruction sequentially displays the images on the pages, each of which configures a document being displayed, in order of pages in the image display area 41.

Now, a description will be given with respect to the variety of data tables 23 to 26 for managing a document in the file management apparatus 1 configured as described above.

The file management apparatus 1 stores the data which configures each document targeted to be managed as a file in the HDD 15 or the like. A file of data which configures the document stored in the HDD 15 is managed by the first file management table 23 and the second file management table 24. The document corresponding to the file stored in the HDD 15 is managed by the document management table 25. In the document map 42 of the reference search screen 40, the colors of the bars indicating the documents each are managed by the color management table 26.

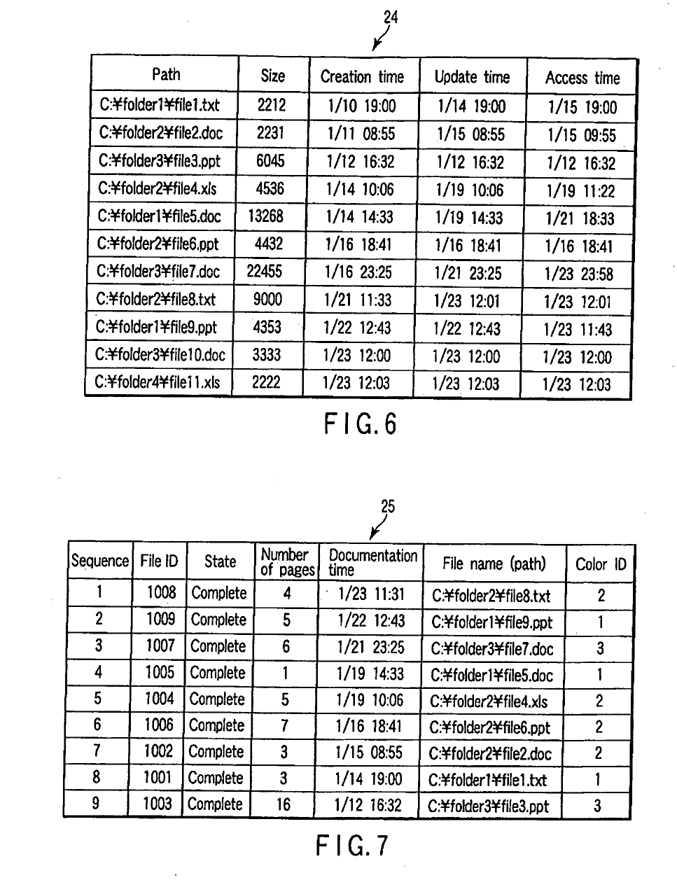

A description will be given with respect to the first file management table 23 and the second file management table 24. FIG. 5 shows an example of a configuration of the first file management table 23. FIG. 6 shows an example of a configuration of the second file management table 24.

The first file management table 23 and the second file management table 24 each store management information relating to each file serving as each document managed by the file management apparatus 1.

As shown in FIGS. 5 and 6, the first file management table 23 and the second file management table 24 each have areas, each of which stores a path, a size, a creation time, an update time, an access time and the like as management information on each file.

The path area stores information which indicates a drive name and a folder name where a file exists and information indicating a file name of a file. The size area stores a data size of a file. The creation time area stores a date and time when a file has been created. The update time area stores a date and time when a file has been updated. The access time area stores a date and time when the latest access has been provided to a file.

The first file management table 23 stores the management information on each file at the past time point. The past time point is provided as, for example, a time point at which the file management apparatus 1 has been started up previously.

In response to this startup, the second file management table 24 stores the current management information on each file. Therefore, the second file management table 24 is updated according to file update and addition at any time.

For example, when the file management apparatus 1 is started up, information of the second file management table 24 at that time point is stored as a first file management table. Concurrently, the second file management table 24 stores management information relating to a newly added file and an updated file.

Therefore, a difference between a file during the previous startup and a file during the current startup appears as a difference between the management information stored in the first file management table 23 and the management information stored in the second file management table 24. A file update state (new registration or update) is determined by the difference between the management information stored in the first file management table 23 and the management information stored in the second file management table 24.

As an example of new registration of a file, a description will be given while presuming a case in which the file management apparatus 1 has acquired a document which consists of images on a plurality of pages via the image input interface 14. In this case, the data on the document acquired via the image input interface 14 is stored in the HDD 15 as a file to be newly registered.

At this time, a field for storing management information relating to a newly registered file is added to the second file management table 24. The second file management table 24 stores a path, a size, a creation time, an update time, an access time and the like as management information on the newly registered file. In this case, the management information contained in the first file management table 23 is maintained without being changed.

As an example of file update, a description will be given while presuming a case in which a file has been updated where management information exists in the second file management table 24. In this case, the updated file is overwritten and stored in the existing file contained in the HDD 15.

At this time, the management information on the file updated in the second file management table 24 is rewritten into information such as a size, an update time, or an access time of the updated file. In this case also, the information contained in the first file management table 23 is maintained without being changed.

Now, the document management table 25 will be described here.

FIGS. 7, 8 and 9 each show an example of a configuration of the document management table 25. The document management table 25 manages as a document a file managed by the file management table 23. As shown in each of the figures, the document management table 25 stores the management information relating to a document, such as a sequence, a document ID, a state, the number of pages, a documentation time, a file name, and a color ID.

The sequence area stores information indicating the sequence of displaying documents. Each document is displayed in order of time series based on the documentation time on the document search screen 40 as shown in FIG. 3. Therefore, in the document management table 25, the sequence of the documents is managed in order from the latest documentation time.

The document ID area stores unique ID information assigned to each document for identifying each document.

The state area stores information indicating a processing state of each document. For example, the state area stores information indicating that an “update” state is established or information indicating that a “complete” state is established. The “complete” area indicates a state in which document update (update or new registration) is completed. The “update” area indicates that a document update (update or new registration) wait state is established.

The number of pages area stores information indicating the number of pages of a document. The number of pages is established when the document state becomes “complete”.

The documentation time area stores a creation time or an update time of each document. For example, the documentation time area stores an update time of a file which corresponds to a document managed in the first file management table 23.

The file name area stores information indicating a file corresponding a document. For example, the file name area stores a drive name, a folder name, and a file name relevant to a file which corresponds to each document.

The color ID area stores information indicating a color for displaying information indicating each document. The color ID is provided as unique ID information assigned to each color for identifying a color. The information indicating an actual color which corresponds to a color ID is stored in the color management table 26.

The document management table 25 is updated by a process for registering document management information described later. For example, nine documents are managed in the document management table 25 shown in FIG. 7. It is assumed that, in this state, a document of document ID “1008” is updated and a document of document ID “1010” and a document of document ID “1011” have been newly added.

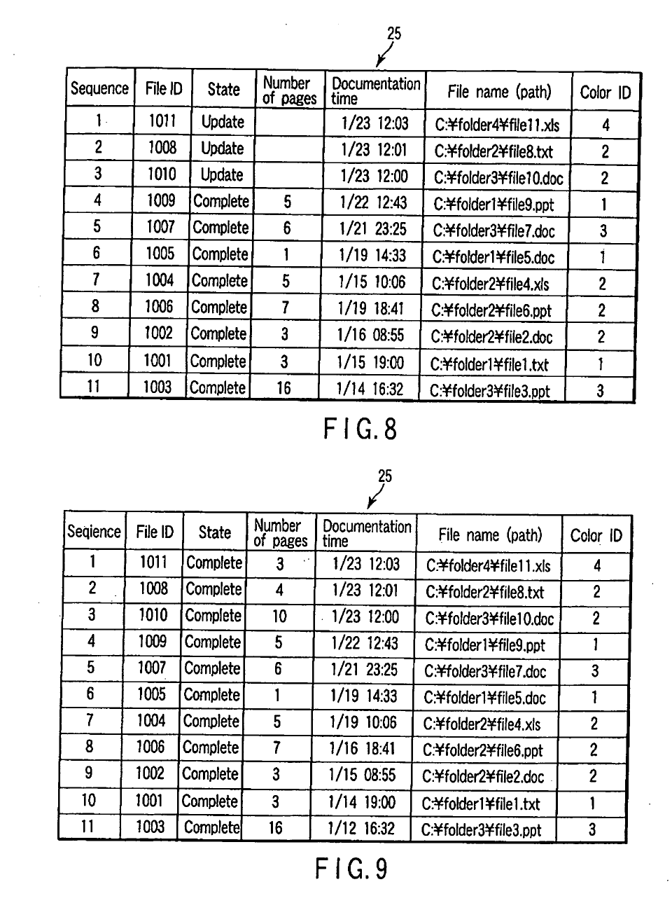

In this case, in the process for registering document management information described later, three documents (document ID “1008”, document ID “1010”, and document ID “1011”) whose state has been set as “update” are registered in the document management table 25 shown in FIG. 7. In this manner, the document management table 25 as shown in FIG. 8 is created.

In the document management table 25 shown in FIG. 8, the state of the three documents of document ID “1008”, document ID “1010”, and document ID “1011” is stored as “update”. An image generating process described later is sequentially carried out with respect to a document whose state is set as “update” in the document management table 25. The document for which the image generating processing has completed is rewritten to the “complete” state.

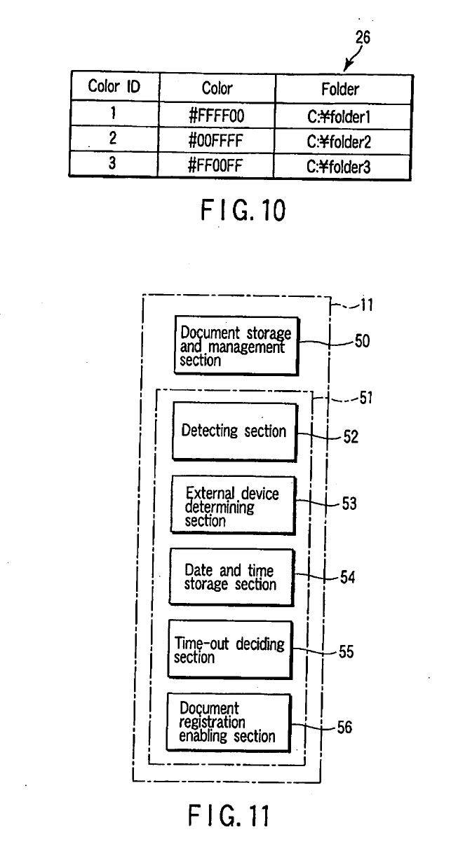

Therefore, when the image processing process has completed for the three documents of document ID “1008”, document ID “1010”, and document ID “1011”, the document management table 25 shown in FIG. 8 is rewritten to the document management table 25 shown in FIG. 9.

The number of pages in each document is established by the number of images generated by the image generating process described later. In this manner, as shown in FIG. 8, the number of pages in each document whose state is “update” is blanked in the document management table 25. Therefore, for the document whose state is changed from “update” to “complete”, the number of images generated by the image generating process described later is stored as the number of pages, as shown in FIG. 9.

Now, the color management table 26 will be described below.

FIG. 10 shows an example of a configuration of the color management table 26. The color management table 26 associates a color ID, a color (information indicating an actual color), and a folder with one another. The document management table 25 indicates the color associated with each document by a color ID. Therefore, the color associated with each document is determined by the color ID of the document management table 25 and the color of the color management table 26. The color associated with each document is provided as a color of a bar which corresponds to each document displayed on the document map 42 of the document search screen 40.

In the present embodiment, the color of the bar corresponding to each document displayed on the document map 42 of the document search screen 40 is set for each folder. Therefore, the color management table 26 indicates the color ID and color which correspond to each folder, as shown in FIG. 10.

In the case where the color of the bar corresponding to each document displayed on the document map 42 is set for each file extension or each application for opening a document, the color management table 26 stores the color ID and color corresponding to such each extension or application.

Now, a description will be given with respect to a print command instructing process for issuing a print command.

The CPU 11 executes a program of a print command instructing process, thereby issuing a print command regardless of a monochrome or a color through an application program for starting up a target document from among the documents, each of which is stored in the HDD 15, for example.

That is, the CPU 11 has a document storage and management section 50 and a print command section 51, as shown in FIG. 11, by executing the document management program 27. The document storage and management section 50 has the function for registering document management information; the function for generating an image; the function for displaying a document search screen; the function for generating a document map; and the function for making a search for a document, as described above. That is, the document storage and management section 50 stores and manages, for example, a plurality of files as a plurality of documents in the HDD 15 or the like.

The print command section 51 issues a print command to the image input/output device 2 via the image input interface (I/F) 14 regardless of a monochrome or a color through an application program for starting a target file from among the files, each of which is stored in the HDD 15.

The print command section 51 designates monochrome printing and color printing at the same time. In this case, the print command section 51 designates the number of monochrome prints and the number of color prints at the same time. The number of monochrome prints and the number of color prints are designated by displaying a window used for designating them on the display screen of the display device 17, for example. The number of monochrome prints and the number of color prints are designated for one file.

The print command section 51 issues a monochrome print command, and issues a color print command after monochrome printing has completed. Specifically, the print command section 51 designates the number of monochrome prints and the number of color prints at the same time, starts up each application program of a target file, and then, issues a monochrome print command. After monochrome printing has completed, the print command section issues the print command for color printing if the number of color prints is not zero. In the case where monochrome printing occurs, only color printing is carried out.

The print command section 51 has the setting of a print option to the monochrome printing and/or color printing of the target file. The print option has at least one of double sided printing, single sided printing, reduction printing, two-in-one printing, and printing or stapler processing of a plurality of, for example, two printing media at the same time.

The two-in-one printing prints two pages on one print medium, for example. For example, a plurality of pages may be printed on one printing medium without being limited to the two-in-one printing. The stapler processing staples a plurality of printed media by means of a stapler. In the print option, another printing process may be set.

The print option is designated by displaying a window for designating it on the display screen of the display device 17, for example.

The print command section 51 issues a monochrome print command prior to a color print command in the case where monochrome printing and color printing are designated at the same time.

The print command section 51 specifically has a search section 52, a number-of-prints designating section 53, an application specifying section 54, an application startup section 55, and a print command generating section 56.

The search section 52 makes a search for a target file from among the files stored in the HDD 15. For example, a keyword for making a search for a target file is inputted for making a search for the target file. The search section 52 makes a search for a file associated with the keyword from among the files stored in the HDD 15. The search section 52 displays a file of a search result on, for example, the display screen of the display section 17. If there are a plurality of searched files, the user designates the target file from among the plurality of files displayed on the display screen of the display device 17.

The number-of-prints designating section 53 designates the number of monochrome prints and the number of color prints of the target file searched by the search section 52 at the same time. This section also designates a print option.

The application specifying section 54 specifies an application program capable of carrying out printing by opening the target file.

The application startup section 55 reads the target file without broadcasting the application program specified by the application specifying section 54, i.e., without displaying the application program on the display device 17, and starts up the file in a background mode.

The print command generating section 56 designates monochrome printing, designates the number of monochrome prints to be printed, and issues a print command after a print option has been notified to the application program started up by the application startup section 55. After the application program has completed the monochrome printing process, the print command generating section designates color printing, designates the number of color prints to be printed, and issues a print command.

Now, a description will be given with respect to a process for registering document management information in the file management apparatus 1.

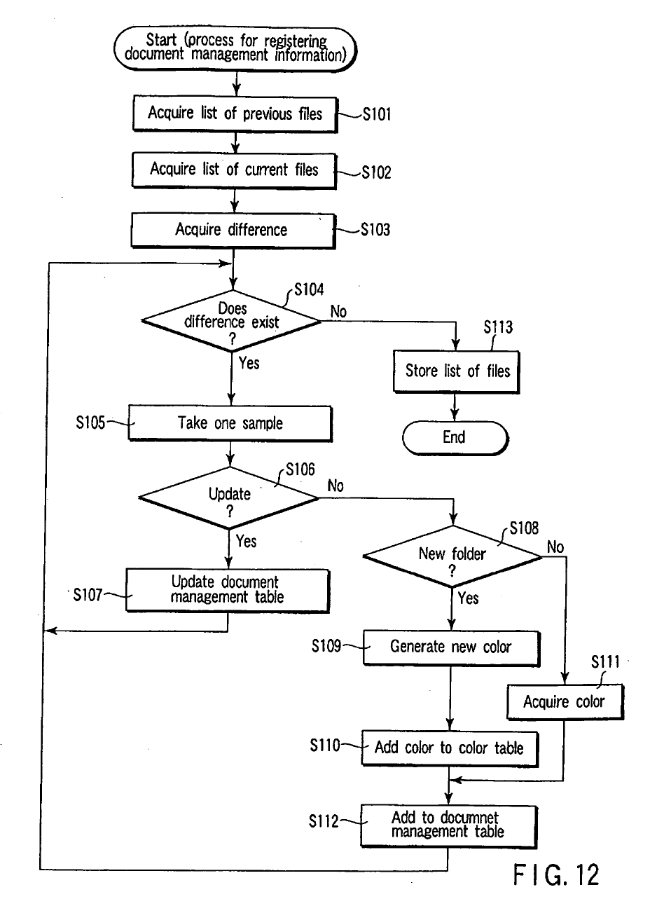

FIG. 12 is a flow chart for explaining the process for registering document management information in the file management apparatus 1.

In the case where the file management apparatus 1 is started up, namely, in the case where a PC serving as the file management apparatus 1 starts up the document management program 27, the CPU 11 reads out the first file management table 23 from the inside of the HDD 15 as previous file information (step S101).

Next, the CPU 11 reads out the second file management table 24 from the inside of the HDD 15 as current file information (step S102).

Next, the CPU 11 carries out a detecting process for a differential file for detecting a difference between management information (previous file information) on all the files stored in the first file management table 23 and management information (current file information on the all files stored in the second file management table 24 (step S103). The information indicating the differential file detected by the differential file detecting process is temporarily stored in, for example, the RAM 12 or the like.

The differential file detecting process denotes a process for extracting an updated file or a newly added file between creation of the previous file information and that of the current file information. The access time is not targeted to be detected as a differential file.

That is, the CPU 11 determines that a file which does not exist in the previous file information, but exists in the current file information, is a newly added file. That is, the CPU 11 determines that a file which exists only in the second file management table 24 is a newly added file.

The CPU 11 determines that a file which is different from another file in update time in the current file information and update time in the previous file information is an updated file. That is, the CPU 11 determines that a file which is different from another file in the first file management table 23 and the second file management table 24 is an updated file.

The CPU 11 determines that a file which does not exist in the current file information, but exists in the previous file information, namely, a file which exists in only the first file management table 23, is a deleted file.

For example, in the process for detecting the differential file between the first file management table 23 shown in FIG. 5 and the second file management table 24 shown in FIG. 6, three fine names “file8.txt”, “file10.doc”, and “file11.xls” are detected as differential files.

In this case, a file (file name “file8.txt”) in path “C:¥folder2¥file8.txt” is different from another file in update time. Therefore, it is determined that the file whose file name is “file8.txt” is an updated file.

A file (file name “file10.doc”) in path “C:¥folder3¥file10.doc” and a file (file name “file11.xls”) in path “C:¥folder4¥file11.xls” exist in only the second file management table 24. Therefore, it is determined the file whose file name is “file10.doc” and the file whose fine name is “file11.xls” are newly added files.

In the case where a differential file has been detected (step S104, YES), the CPU 11 sequentially reads out management information on the differential file, and carries out a process for updating the document management table 25 (step S105 to step S112). The process for updating the document management table 25 is repeatedly executed until processing has completed for all the differential files detected by the differential file detecting process.

That is, in the case where a differential file exists (step S104, YES), the CPU 11 reads out one item of management information on the differential file (step S105). Next, the CPU 11 determines whether the differential file is an updated file (a file whose update time has been changed) or a newly added file (step S106).

As a result of this determination; in the case where the read-out differential file is an updated file (step S106, YES), the CPU 11 carries out a process for updating management information on a document which corresponds to the file in the document management table 25 (step S107).

On the other hand, in the case where it has been determined that the differential file is not an updated file, namely, in the case where it has been determined that the differential file is a file to be newly added (step S106, YES), the CPU 11 determines whether or not the differential file is stored in a newly created folder (a new folder) (step S108).

That is, the CPU 11 determines whether or not the color of the folder storing a file is managed by the color management table 26. When the color of the folder is managed by the color management table 26, the CPU 11 determines that the managed color is an existing folder. When the color of the folder is not managed by the color management table 26, the CPU 11 determines that the folder is a new folder.

For example, a file in path “C:¥folder3¥file10.doc” is stored in a folder “C:¥folder3”. In the color management table shown in FIG. 10, a color has been already assigned to the folder “C:¥folder3”. Therefore, the CPU 11 determines that the folder “C:¥folder3” is not a new folder.

In contrast, a file in path “C:¥folder4¥file11.xls” is stored in a folder “C:¥folder4”. In the color management table shown in FIG. 10, no color is assigned to the folder “C:¥folder4”. Therefore, the CPU 11 determines that the folder “C:¥folder4” is a new folder.

In the case where the above folder is a new folder (step S108, YES), the CPU 11 generates a color to be assigned to the new folder (step S109). For example, the CPU 11 assigns to the new folder a new color which is not assigned to another folder. A unique color ID is assigned to the thus generated color. When the color assigned to the new folder is generated, the CPU 11 adds the color to the new folder and color information obtained by associating the above color and its color ID with each other to the color management table 26 as color information (step S110).

Next, the CPU 11 carries out a new file adding process for adding to the document management table 25 management information on a file which corresponds to a differential file (step S112).

In the case where the current folder is not a new folder (step S108, YES), the CPU 11 acquires the color ID assigned to the folder in which the file is stored, in accordance with the color management table 26 (step S111). In this case, the CPU 11 carries out a new document adding process for adding to the document management table 25 management information on a document which corresponds to a differential file (step S112).

In the new document adding process of the above steps S111 and S112, the CPU 111 generates management information on a document which corresponds to a newly added file with reference to the second file management table 24 and the color management table 26.

For example, an update time of a differential file is used as a documentation time in document management information. A path of the differential file is used as a file name in the document management information. Newly generated unique information is used as a document ID in the document management information because this ID is identified from that of the existing file. A color ID associated with a folder storing the differential file is used as the color ID in the document management information.

However, the number of pages in the document management information is blanked. A state in the document management information is indicated as “update”. This is because, when image data is generated from the file by using an image generating process described later, the number of pages in the document management information is determined.

In the case where no differential file has been detected, or alternatively, in the case where a process has completed for all the differential files (step S104, NO), the CPU 11 moves to the first file management table 23 the current information stored in the second file management table 24 serving as file information during current startup (step S113). At this time, the CPU 11 erases the information stored in the second file management table 24.

Consequently, the first file management table 23 stores file information when the differential file detecting process has been carried out (during the current startup). In this manner, during next startup, the information stored in the first file management table 23 is used as the previous file information.

As a result, in the document management table 25, the state of the management information on a document corresponding to an updated file and management information on a document for a newly added file is registered as “update”. A file whose state is “update” is changed to “complete” by executing a process for generating an image of a file described later, and the number of pages is determined.

Now, a process for generating an image of a document will be explained below.

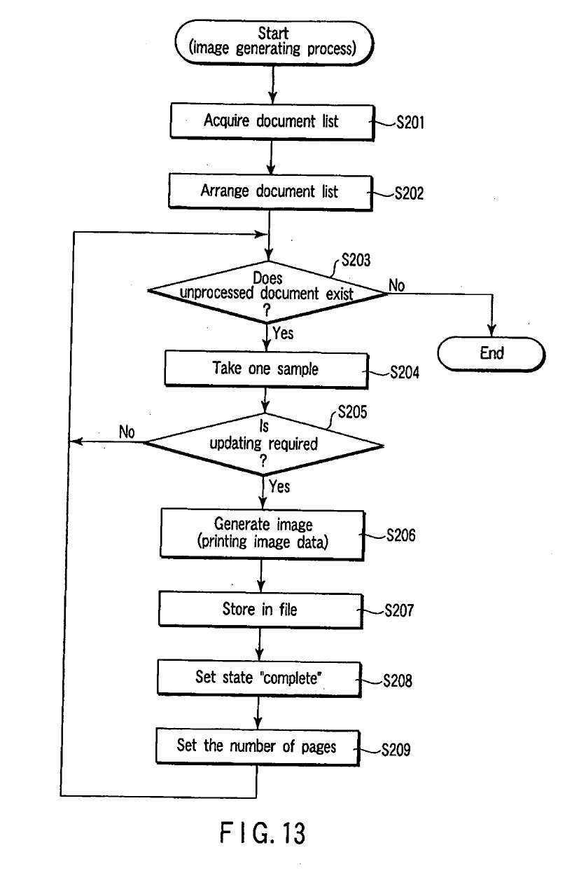

FIG. 13 is a flow chart for explaining the process for generating an image of a document in the file management apparatus 1.

In the process for registering document management information, an updated file and management information on a document corresponding to a newly registered file are registered in the document management table 25 as an “update” state. The file in the “update” state indicates that a display image is not generated. Therefore, it is necessary to generate a display image for a document whose “state” is “update”. A process for generating an image for displaying a document is referred to as an image generating process.

When the process for registering document management information completes, the CPU 11 carries out the image generating process for displaying a display image. When the image generating process is started up, the CPU 11 reads out the management information on all the documents from the document management table 25 (step S201).

Next, the CPU 11 controls the management information on all the documents to be arranged based on the documentation time in the management information on each file (step S202). In this manner, the document management table 25 enters a state in which the management information on all the documents is rearranged in order of documentation times (in order of time series). For example, in FIG. 8, the latest three documents each enter an “update” state.

Next, the CPU 11 determines whether or not there exists a document for which an image generating process is not applied (an unprocessed document) (step S203). When it is determined that an unprocessed document(s) exist(s), the CPU 11 reads out the management information on such unprocessed documents on a one by one basis (step S204).

The CPU 11 then determines whether or not the “state” in the management information on the read-out document enters. “update” (step S205). In the case where it is determined that the “state” enters “update” (step S205, YES), the CPU 11 carries out a process for generating an image for displaying the document (step S206).

In the image generating process, for example, a bit map image of each page configuring a document is generated as an image for displaying the document. The image data for displaying the document is generated as, for example, printing image data. The data contained in each document is formed in a variety of data formats such as text data or image data.

The file management apparatus 1 manages a document which consists of variously formed data. The file management apparatus 1 generates data on each page configuring a document, respectively, as printing image data.

In general, the variously formed data for use in a variety of application programs generate a printing image in the application program. For example, in the case where a document contains text data, the document display image is generated as a printing image by, for example, an application program of a word processor.

Next, the CPU 11 stores in the HDD 15 the images on the pages, each of which configures a document, (image data for displaying each page), as an image data file (step S207). In this manner, the image data file for the number of pages in a document is stored in the HDD 15.

Next, the CPU 11 changes to “complete” the “state” in the management information on the document in the document management table 25 (step S208).

The CPU 11 then specifies the number of pages from the number of files generated as image data, and sets the number of pages as management information on the document in the document management table 25 (step S209).

In the case where no unprocessed document has existed, namely, in the case where the “state” of all the documents in the document management table 25 has been changed to “complete” (step S203, NO), the CPU 11 terminates the image generating process.

In this manner, the image data for displaying each document is generated as one document on a page by page basis of each document. The image data for displaying each document may be in any format. For example, a JPEG format is used for display image data.

However, with respect to each file of display image data as an image on each page, a file name can be specified from the document ID and page number. For example, the files of display image data each are stored by its file name “document ID-page number.jpg”.

For example, in the document management table 25 shown in FIG. 8, a document “C:¥folder4¥file11.xls” is composed of, for example, images made of three pages. In this case, the image generating process for displaying the document “C:¥folder4¥file11.xls” generates image data for displaying three pages (three files of image data in the JPEG format).

The document “C:¥folder4¥file11.xls” has a document ID “1011”, as shown in FIG. 8. In this manner, the items of image data for displaying the document “C:¥folder4¥file11.xls” are generated as three files “1011-001.jpg”, “1011-002.jpg”, and “1011-003.jpg”.

In this case, for the management information on a document whose document ID is “1011” in the document management table 25 shown in FIG. 8, the “state” is set to “complete” and “the number of pages” is set to “3”, as shown in FIG. 9. FIG. 9 shows an example of the document management table 25 in the case where the above image generating process has completed for the document management table 25 in the state shown in FIG. 8.

The image generating process may be executed in parallel to another process. The image generating process may be executed in a background of another process. For example, in the case where many documents enter “update” in their “state”, or alternatively, in the case where there are a large number of pages of the document which enters “update” in their “state”, there is a possibility that a large amount of time intervals is required for the image generating process. Therefore, even if the image generating process is in execution, the CPU 11 may carry out a process for displaying the document search screen 40 as described later, or the like.

Now, a description will be given with respect to a display process when displaying the above document search screen (document search display window) 40.

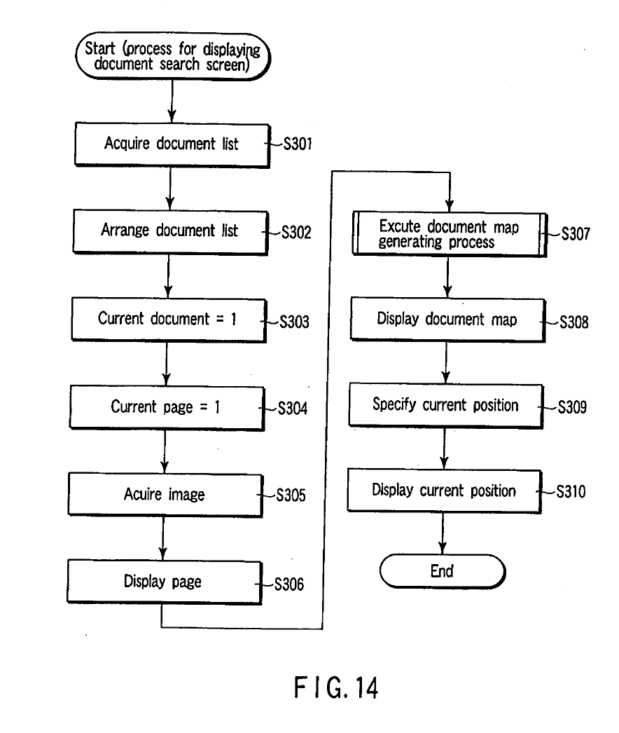

FIG. 14 is a flow chart for explaining the process for displaying the document search screen 40.

First, in the case where the document search screen 40 is displayed (started up), the CPU 11 reads the management information on all the documents stored in the document management table 25 (step S301).

Next, the CPU 11 controls the management information on all the read documents to be arranged sequentially from the latest order (time series) of documentation time (step S302).

The CPU 11 then allocates a storage area of a current document (display document) for storing information which indicates a currently displayed document on the RAM 12, for example. Next, the CPU 11 sets information indicating the newest document in the current document storage area (step S303).

Here, in the current document storage area, the “sequence” stored as document management information is set in the document management table 25 as information indicating a current document. In other words, the CPU 11 indicates a currently displayed document (current document) in accordance with the “sequence” assigned to each document.

The CPU 11 allocates onto, for example, the RAM 12, the storage area of a current page (display page), for storing information indicating the number of pages in the currently displayed document. Next, the CPU 11 sets information indicating a typical page of a document (a first page in the present embodiment) in the current page storage area (step S304). Here, the CPU 11 sets the number of pages in the current page storage area as information indicating the current page.

That is, the CPU 11 displays a typical page (a first page) of the newest document as an initially displayed image. The CPU 11 sets the current document to “1” and sets the current page to “1”. In this manner, the CPU 11 acquires a file of image data for displaying an image of page “1” in a document whose sequence is “1” (step S305).

In the image acquisition process, a file of image data on a page to be displayed by referring to the document management table 25 is specified. That is, the CPU 11 acquires a document ID corresponding to the “sequence” (“1” in this case) set as a current document by referring to the document management table 25.

Next, the CPU 11 specifies a file of image data which consists of a document ID and the page number of the current document in accordance with the “page number” (“1” in this case) set as the current page.

For example, in the document management table 25 shown in FIG. 9, the document ID whose “sequence” is 1 is obtained as “1011”. An image file on the first page of the document ID “1011” is stored with the file name “1011-001.jpg”.

Therefore, in the case where, the current document is set to “1”, and the current page is set to “1”, the CPU 11 specifies the file name “1011-001.jpg” as a file of image data by referring to the document management table 25 shown in FIG. 9.

Next, the CPU 11 displays the file image data in the image display area 41 of the document search screen 40 (step S306).

Next, the CPU 11 carries out a document map generating process for generating the document map 42 which indicates all the documents in order of time series (step S307). This document map generating process will be described later in detail.

Next, the CPU 11 then displays the generated document map 42 in a predetermined display area on the document search screen 40 (step S308). Next, the CPU 11 specifies the position of the current document in the document map 42 (step S309). When the position of the current document is specified, the CPU 11 displays an arrow 43 indicating the position of the current document on the document map 42 (step S310).

As a result, on the display device 17, a startup screen serving as the document search screen 40 is displayed in the display window.

Now, the document map generating process will be described here.

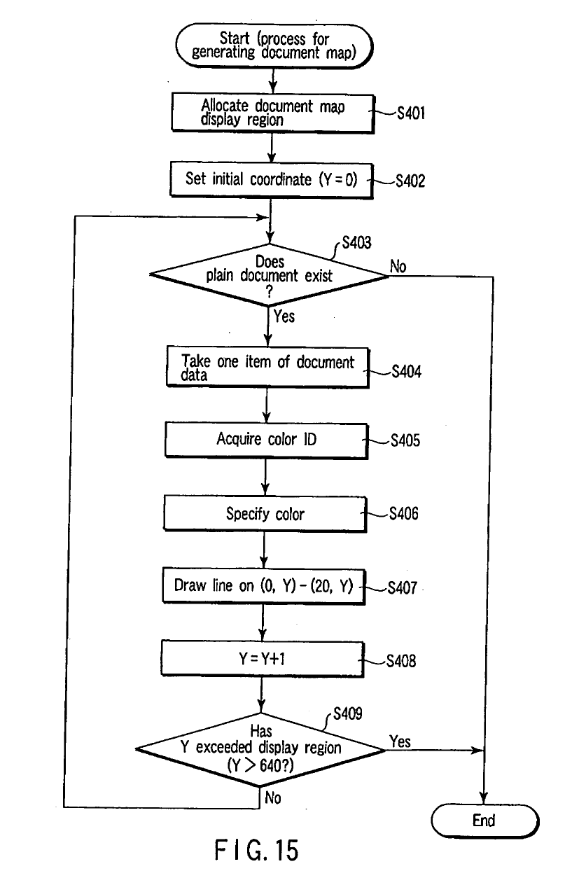

FIG. 15 is a flow chart for explaining the document map generating process. When the process for generating the document map 42 is started, the CPU 11 allocates a display area for displaying the document map 42 on the document search screen 40 (step S401). The display area of the document map 42 is preset. In addition, in the above step S401, the CPU 11 displays the allocated display area of the document map 42 as an initial value such as a white.

The display area of the document map 42 is set as, for example, an area of 20 pixels in width and 640 pixels in height at the right end of the document search screen 40, as shown in FIG. 3. Here, the display area of the document map 42 will be described, assuming a case in which the coordinate value (X, Y) is a rectangular area indicated by points (0, 0), (20, 0), (0, 640), and (20, 640), as shown in FIG. 3.

Next, the CPU 11 sets an initial coordinate value for starting depicting (step S402). Here, with respect to the initial coordinate value, the Y coordinate is set to “0” (Y=0) while it is defined as the top end of the display area of the document map 42.

Next, from the document management table 25, the CPU 11 reads out document management information sequentially in order of fewer sequences. That is, the CPU 11 determines whether or not a document for which no bar is depicted in the display area of the document map 42 (a plain document) exists in the above document management table 25. As a result of this determination, in the case where it has been determined that a plain document exists in the document management table 25 (step S403), the CPU 11 reads out the management information on a document whose “sequence” is the lowest from among the plain documents (step S404).

Next, the CPU 11 specifies a color ID assigned to the read-out document (step S405). When the color ID of the document is specified, the CPU 11 allocates an actual color which corresponds to the color ID of the document by referring to the color management table 26 (step S406). In this manner, the determined color is provided as a color for depicting a bar (line) which indicates the document in the document map 42.

The CPU 11 then depicts the bar (line) indicating a document by a color on the current coordinate value in the display area of the document map 42 (step S407). The bar indicating each document is provided as a line having a width (height) for one pixel in the Y direction. The CPU 11 depicts a bar of a first document, for example, with a width (height) for one pixels in the Y initial coordinate value ((0, Y) to (20, Y)) in the display area of the document map 42.

Next, the CPU 11 increases the coordinate value for one pixel by setting “Y=Y+1” (step S408). The CPU 11 then determines whether or not the coordinate value in the Y direction has exceeded the display area of the document map 42. As a result of this determination, in the case where it is determined that the coordinate value in the Y direction has exceeded the display area of the document map 42 (step S409, YES), the CPU 11 terminates the process for generating the document map 42.

On the other hand, in the case where it is determined that the coordinate value in the Y direction does not exceed the display area (step S409), NO), the CPU 11 returns to step S403. In this manner, the CPU 11 repeatedly executes steps S403 to S409 until no plain document has disappeared from the display area of the document map 42. That is, the processes in the steps S403 to S409 are repeatedly executed for all the documents managed by the document management table 25.

As a result, the document map 42 is generated where the bars indicating the documents are displayed to be superimposed in order of time series by the color corresponding to each document.

Now, a document search process will be described here.

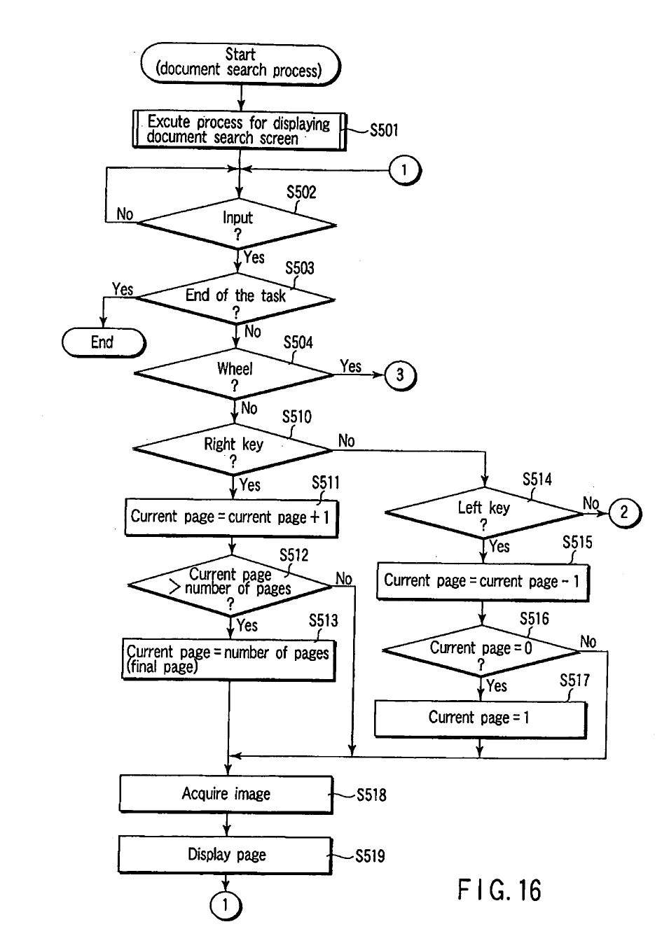

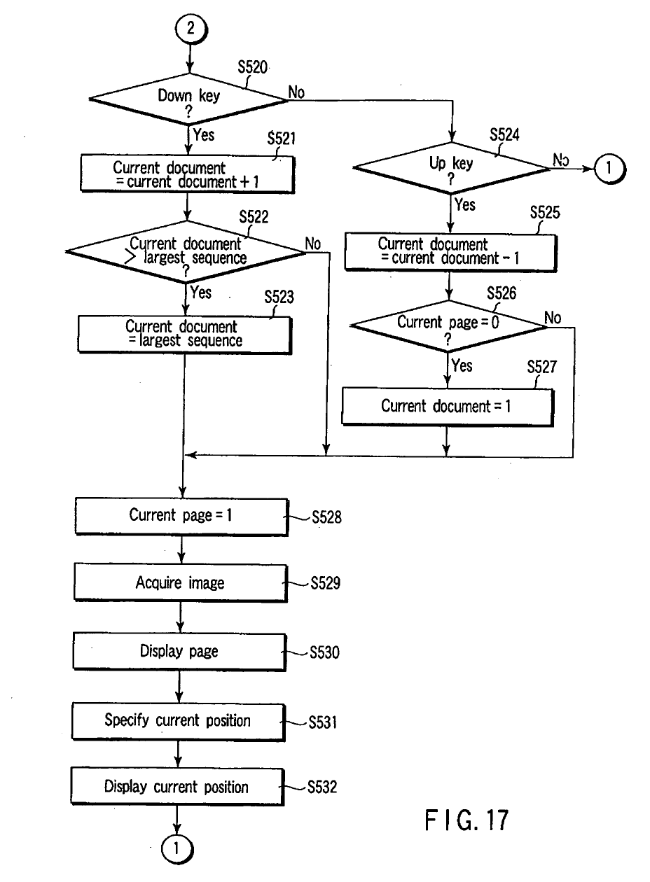

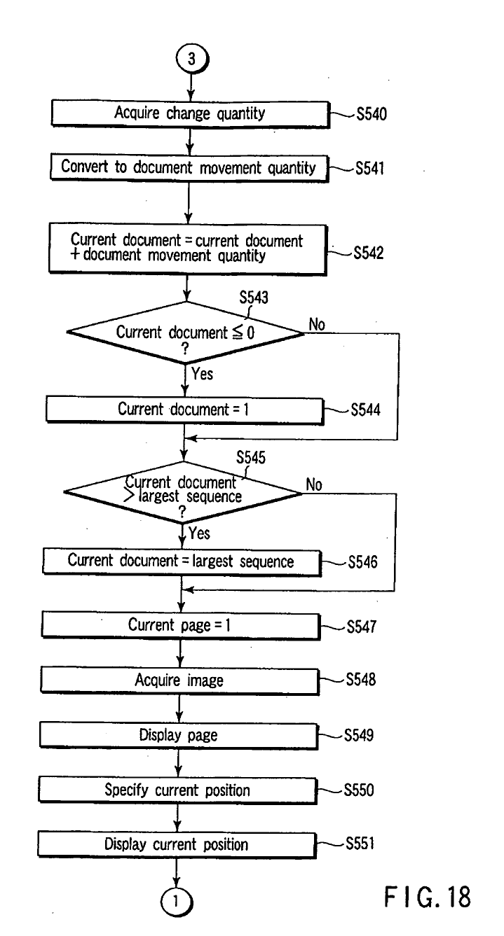

FIGS. 16, 17, and 18 are a flow chart for explaining the document search process.

The document search screen 40 having displayed an image on a first page of a new document whose documentation time is the newest is displayed on the display device 17 by the process for displaying the document search screen (step S501).

In this state, the CPU 11 waits for the user's input by using the mouse 19 or keyboard 21 (step S502). The CPU 11 senses the presence or absence of the input to the mouse 19 or keyboard 21. During the input to the wheel 34 of the mouse 19, the rotation quantity of the wheel 34 in a predetermined period of time is inputted as a change quantity. The input to each key of the keyboard or the left and right buttons 32, 33 of the mouse 19 is sensed as which key has been inputted.

When the input to the mouse 19 or keyboard 21 is sensed (step S502, YES), the CPU 11 determines whether or not the contents of the inputted instruction are an instruction for termination (step S503).

In the case where it is determined that the contents of the instruction inputted by the above determination are an instruction for termination (step S503, YES), the CPU 11 clears the document search screen 40 and terminates processing.

On the other hand, in the case where it is determined that the inputted contents of instruction are not an instruction for termination (step S503, NO), the CPU 11 determines whether or not the inputted contents of instruction have been the input to the wheel 34 (step S504).

In the case where it is determined that the above contents are not the input of the mouse 19 to the wheel 34 (step S504, YES), the CPU 11 determines the input to the right key for instructing a right movement (step S510); the input to the left key for a left movement (step S514); the input to the down key for instructing a downward movement (step S520); or the input to the up key for instructing an upward movement (step S525). If a key input other than the right key, the left key, the down key, and the up key occurs, the CPU 11 returns to step S502 in which an input wait state is established again.

In the case where it is determined that the input is the right key (step S510, YES), the CPU 11 increases the current page on a one by one page basis, and “current page=current page+1” is established (step S511). In this case, the CPU 11 acquires the number of pages in the current document from the document management table 25, and checks whether or not the current page set in step S511 exceeds the number of pages in the current document (step S512).

In the case where it is determined that the current page set in step S511 exceeds the number of pages in the current document, the CPU 11 set the current page as the number of pages in the current document, namely, a last page of the current document (step S513).

In the case where the input is the left key (step S514, YES), the CPU 11 reduces the current page on a one by one page basis, and “current page=current page−1” is established (step S515). In this case, the CPU 11 checks whether or not the current page to be displayed is set to 0 (step S516).

In the case where it is determined that the current page set in step S515 is set to “0”, the CPU 11 sets the current page to “1”, namely, a first page of the current document (step S517).

When the current page is changed in accordance with steps S510 to S517, the CPU 11 acquires the document ID of the current document in accordance with a correlation between the “sequence” and the “document ID” in the document management table 25.

When the document ID of the current document, the CPU 11 acquires a file of an image on the page based on the document ID and current page of the current document (step S518). Next, the CPU 11 displays the image of the page in the image display area 41 of the document search screen 40 (step S519).

In the case where it is determined that the input is the down key (step S520, YES), the CPU 11 increases the current document on a one by one basis, and “current document=current document+1” is established (step S521). In this case, the CPU 11 acquires the largest sequence (“sequence of a document whose documentation time is the earliest) from the document management table 25. Next, the CPU 1 checks whether or not the current document set in the step S521 exceeds the maximum sequence (step S522).

Here, in the case where it is determined that the current document set in the step S521 exceeds the largest sequence, the CPU 11 defines the current document as the largest sequence, namely, as a document whose documentation time is the earliest (step S523).

In the case where it is determined that the input is the up key (step S524, YES), the CPU 11 reduces the current document on a one by one basis and “current document=current document−1” is established (step S525). In this case, the CPU 11 checks whether or not the current document set in step 5525 is set to “0” (step S526).

In the case where it is determined the current document set in step S525 is set to “0”, the CPU 11 sets the current document to “1”, namely, as a document whose documentation time is the latest (step s527).

When the current document is changed in accordance with steps S520 to S527, the CPU 11 sets the current page to “1” which serves as a typical page of each document (step S519). When the current document and the current data are thus set, the CPU 11 acquires the document ID of the current document in accordance with a correlation between the “sequence” and the. “document ID” in the above document management table 25.

Next, the CPU 11 acquires a file of an image of the page in accordance with the document ID and the current page of the current document (step S529). Next, the CPU 11 displays an image of the page in the image display area 41 of the document search screen 40 (step S530).

Next, the CPU 11 specifies the position of the current document in the document map 42 of the document search screen 40 (step S531). Next, the CPU 11 displays an arrow 43 indicating the position of the current document in the document map 42 of the document search screen 40 (step S531). Next, the CPU 11 displays the arrow 43 indicating the position of the current document in the document map 42 (step S532). The processes in steps S531 and S532 may be carried out in parallel to those in steps S528 to S530.

In the case where it is determined that the input to the wheel 34 of the mouse 19 has occurred (step S504, YES), the CPU 11 acquires the rotation quantity of the above wheel 34 in a predetermined period of time as a change quantity (step S541).

The rotation quantity of the wheel 34 is detected by means of the mouse driver 18. The rotation quantity of the wheel detected by the mouse driver 18 is notified to the CPU 11. In this manner, the CPU 11 acquires the rotation quantity of the wheel 34 in the predetermined period of time as a change quantity.

Next, the CPU 11 converts the acquired change quantity as a document movement quantity (step S504). The document movement quantity indicates the number of documents whose display is to be changed (the number of documents to be moved). The document movement quantity indicates which direction a document is to be moved in. A relationship among the rotation quantity, change quantity, and document movement quantity of the wheel 34 will be described later in detail.

For example, in the case where the wheel 34 has been rotated in the forward direction, the document movement quantity is obtained as a positive value. The document movement direction moves in order of the sequence“of documents. On the other hand, in the case where the wheel 34 has been rotated in the backward direction, the document movement quantity is obtained as a negative value. The document movement direction moves in the reverse order of the “sequence” of the documents.

When the change quantity based on the rotation quantity inputted to the wheel 34 is converted to the document movement quantity (step S541), the CPU 11 sets the current document to a document moved by the document movement quantity (current document=current document+document movement quantity” (step S542).

In this case, the CPU 11 checks whether or not the current document set in step S542 is equal to or smaller than “0” (step S543). In the case where it is determined that the current document set in step S542 is equal to or smaller than 0 (step S543, YES), the CPU 11 sets the current document as “1”, namely, as a document whose documentation time is the latest (step S544).

In the case where it is determined that the current document is not equal to or smaller than “0” (step S543, NO), the CPU 11 acquires the largest sequence (“sequence” of a document whose documentation time is the earliest) from the document management table 25. Next, the CPU 11 checks whether or not the current document set in step S542 exceeds the largest sequence (step S545).

Here, in the case where it is determined the current document set in step S542 exceeds the largest sequence (step S545, YES), the CPU 11 sets the current document as the largest sequence, namely, as a document whose documentation time is the earliest (step S546).

Next, the CPU 11 sets the current page to “1” which serves as a typical page of each document (step S547). In this manner, the current document and the current page are set.

Next, the CPU 11 acquires the document ID of the current document in accordance with a correlation between the “sequence” and “document ID” in the document management table 25.

The CPU 11 then acquires a file of an image on the page in accordance with the document ID and current page of the current document (step S548).

Next, the CPU 11 displays the image of the page in the image display area 41 of the document search screen 40 (step S549).

Next, the CPU 11 specifies the position of the current document in the document map 42 of the document search screen 40 (step S550). When the position of the current document 440 is specified, the CPU 11 displays the arrow 43 indicating the position of the current document in the document map 42 (step 551). The processes in steps S550 and S551 each may be executed in parallel to those in steps S547 to S549.

The change quantity in accordance with the rotation quantity of the wheel 34 o the mouse 19 thus inputted by the user is converted to the document movement quantity, and a document which displays an image on a first page is changed to the display device in accordance with the document movement quantity. In this manner, the wheel 34 of the mouse 19 is rotated, making it possible to efficiently change the document which displays the image on the first page. As a result, the user can make a search for the document managed by the file management apparatus 1 efficiently, and can find a desired document easily.

Now, a description will be given with respect to a relationship among the rotation quantity, change quantity, and document movement quantity of the wheel 34 of the mouse 19.

A relationship between the rotation quantity of the wheel 34 of the mouse 19 and the change quantity acquired by the CPU 11 is set in advance in accordance with setting information. A relationship between the change quantity and the document movement quantity acquired by the CPU 11 is also set in accordance with setting information. These items of setting information each can be changed to an arbitrary value by the user.

For example, assume that the change quantity is set to “2880” in response to one rotation of the wheel 34 of the mouse 19. In this case, when the number of documents to be moved is set to “1” while the change quantity is set to “1”, 2880 documents are moved relevant to one rotation of the wheel 34. This denotes that the image displayed in the image display area 41 (image on a typical page of each document) changes an image for 2880 documents by one rotation of the wheel 34.

In such setting, the movement quantity of the documents displayed in the image display area 41 is so large that the user can hardly make a search for a desired document. In such a case, for example, the number of documents to be moved is set to “1” in response to the change quantity “120”. In this manner, 24 documents are moved by one rotation of the wheel 34. Thus, the user easily makes a search for a desired document.

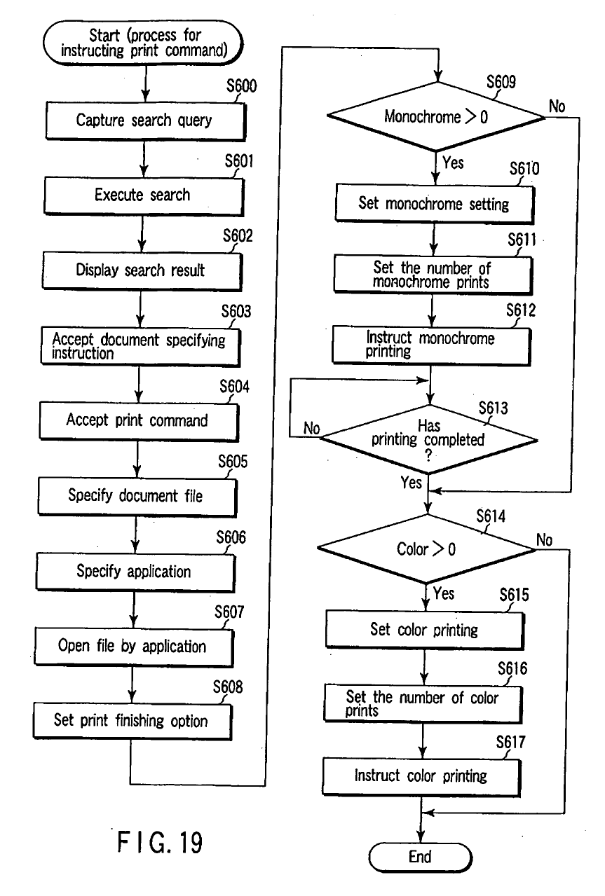

Now, a description will be given with respect to a print command instructing process for issuing a print command. FIG. 19 is a flow chart showing the print command instructing process.

When the user inputs a keyword for making a search for a target file from, for example, the mouse 19 or the keyboard 21, the search section 52 captures the keyword from the mouse 19 or the keyboard 21 (step S600).

Next, the search section 52 makes a search for a file associated with the keyword from among the files stored in a HDD 15 (step S601). The search section 52 displays a file of a search result on, for example, the display screen of the display device 17 (step S602).

Here, if there is a plurality of searched files, the user designates a target file from among the plurality of files displayed on the display screen of the display device 17. That is, the user designates the target file from among the plurality of files by the mouse 19 or the keyboard 21. The target file used here may be one or plural. The CPU 11 recognizes the designated target file (step S603).

Next, a print command section 51 displays a window for designating the number of monochrome prints and the number of color prints, respectively, on, for example, the display screen of the display device 17. The user designates the number of monochrome prints and the number of color prints, respectively, in the window by using the mouse 19 or the keyboard 21. If the number of monochrome prints or the number of color prints is 0, it is assumed that neither monochrome printing nor color printing is designated.

Therefore, monochrome printing and color printing can be designated at the same time, and either of the monochrome printing and the color printing can be designated. In this manner, the print command section 51 recognizes the number of monochrome prints and the number of color prints designated in the window (step S604).

Next, the print command section 51 displays a window for setting a print option on, for example, the display screen of the display device 17. Here, the user designates, for example, double sided printing, single sided printing, reduction printing, two-in-one printing, and printing or stapler processing of a plurality of, for example, two printing media at the same time in the window by using the mouse 19 or the keyboard 21.

If no print option is designated, the designation is not carried out. In this manner, the print command section 51 recognizes the print option if the print option is designated.

When the print command section 51 specifies the target file designated in step S603, the application specifying section 54 specifies an application program capable of carrying out printing by opening the target file searched by the search section 52 (step S606).

Next, the application startup section 55 reads the target file without broadcasting, i.e., displaying the application program specified by the application specifying section 54, and starts up the file in a background mode (step S607).

Next, the print command generating section 56 designates a print option to the started-up application program (step S608).

Next, the print command generating section 56 determines whether or not the number of monochrome prints is equal to or greater than 0 (step S609). As a result of this determination, if the number of. monochrome prints is equal to or greater than 0, the print command section 56 provides setting for executing monochrome printing with respect to the application program started up by the application startup section 55 (step S610).

Next, the print command generating section 56 then provides setting of the number of monochrome prints (step S611).

Next, the print command generating section 56 issues a monochrome print command in accordance with the settings of steps S610 and 611 to the digital composite machine (MFP) which comprises a scanner which is the image input/output device 2, for example.

Next, the print command generating section 56 determines whether or not the monochrome printing process has completed (step S613). If the set monochrome printing process has not completed, the print command generating section 56 waits until the monochrome printing has completed.

When the monochrome printing has completed, the print command generating section 56 determines whether or not the number of color prints is equal to or greater than 0 (step S614). As a result of this determination, if the number of color prints is equal to or greater than 0, the print command generating section 56 provides setting for executing color printing with respect to the application program started up by the application startup section 55 (step S615).

Next, the print command generating section 56 then provides setting of the number of color prints (step S616).

Next, the print command generating section 56 issues a color printing command in accordance with the settings of steps S615 and S616 to the digital composite machine (MFP) which comprises a scanner which is the image input/output device 2, for example. The image input device 2 may be divided into a device used exclusively for monochrome printing and a device used exclusively for color printing.

Thereafter, when color printing of the set number of prints has completed, a process for instructing a print command by the print command section 51 terminates.

The print command section 51 issues the monochrome print command prior to the color print command in the case where monochrome printing and color printing has been designated at the same time. The monochrome printing enables printing for a shorter period of time than the color printing. Therefore, the monochrome printing is carried out prior to the color printing, thereby making it possible to reduce a printing time. Many prints can be obtained within the same period of time, and this printing is effect when all prints cannot be completed within a predetermined time limit.

Although the present embodiment has described a case in which a function of carrying out the invention is recorded in advance inside of the apparatus, a similar function may be downloaded to the apparatus via a network without being limited thereto, or alternatively, a similar function stored in a recording medium may be installed on the apparatus. Any mode of a recording medium may be used as long as it can store a program such as a CD-ROM and can be read by the apparatus. In addition, such a function achieved by pre-installation or downloading may be carried out in corporation with an OS (operating system) inside the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A file management apparatus comprising:
a document storage and management section which stores and manages a plurality of documents; and
a print command section which issues a print command regardless of a monochrome or a color through an application program which starts up a target document from the documents, each of which is stored in the document storage and management section.

2. A file management apparatus according to claim 1, wherein the print command section designates the monochrome printing and the color printing at the same time.

3. A file management apparatus according to claim 1, wherein the print command section designates the number of monochrome prints and the number of the color prints at the same time.

4. A file management apparatus according to claim 1, wherein the print command section issues the print command of the monochrome, and issues the print command of the color after the monochrome print process has completed.

5. A file management apparatus according to claim 1, wherein the print command section designates the number of the monochrome prints and the number of the color prints at the same time; issues the print command of the monochrome after starting up said each application program of the target document; and issues the print command of the color if the number of the color prints is not zero after the monochrome printing has completed.

6. A file management apparatus according to claim 1, wherein the print command section has setting of a print option with respect to monochrome printing and/or color printing of the target document.

7. A file management apparatus according to claim 6, wherein the print command section has at least one of double sided printing, single sided printing, reduction printing, two-in-one printing, and staple processing as the print option.

8. A file management apparatus according to claim 1, wherein, in the case where the monochrome printing and the color printing have been designated at the same time, the print command section issues the print command of the monochrome prior to the print command of the color.

9. A file management apparatus according to claim 1, wherein the print command section has:
a search section which makes a search for a target document from among the documents, each of which is stored in the document storage and management section;
a number-of-prints designating section which designated the number of the monochrome prints and the number of the color prints of the target document searched by the search section at the same time;
an application specifying section which specifies the application program capable of carrying out printing by opening the target document;
an application startup section which reads the target document without broadcasting the application program specified by the application specifying section, and starts up the document in a background mode; and
a print command generating section which instructs the number of the monochrome prints and the number of the color prints of the target document designated by the number-of-prints designating section with respect to the application program started up by the application startup section, and issues the print command of the monochrome or the print command of the color.

10. A document management method comprising:
starting and managing a plurality of documents by a computer; and
issuing a print command regardless of a monochrome or a color through an application program which starts up a target document from the stored documents.

11. A document management method according to claim 10, further comprising designating the monochrome printing and the color printing at the same time.

12. A document management method according to claim 10, further comprising designating the number of monochrome prints and the number of the color prints at the same time.

13. A document management method according to claim 10, further comprising issuing the print command of the monochrome, and issuing the print command of the color after the monochrome print process has completed.

14. A document management method according to claim 10, further comprising:
designating the number of the monochrome prints and the number of the color prints at the same time;
issuing the print command of the monochrome after starting up the application program of the target document; and
issuing the print command of the color if the number of the color prints is not zero after the monochrome printing has completed.

15. A document management method according to claim 10, further comprising setting of a print option with respect to monochrome printing and/or color printing of the target document.

16. A document management method according to claim 15, further having at least one of double sides printing, single sided printing, reduction printing, two-in-one printing, and staple processing as the print option.

17. A document management method according to claim 10, further comprising, in the case where the monochrome printing and the color printing have been designated at the same time, issuing the print command of the monochrome prior to the print command of the color.

18. A file management apparatus according to claim 10, comprising:
making a search for a target document from among the documents, each of which is stored in the computer;
designating the number of the monochrome prints and the number of the color prints of the searched target document at the same time;
specifying the application program capable of carrying out printing by opening the target document;
reading the target document without broadcasting the specified application program, and starts up the document in a background mode; and
instructing the number of the monochrome prints and the number of the color prints of the target document with respect to the started-up application program, and issuing the print command of the monochrome or the print command of the color.

19. A document management program comprising causing a computer to execute:
store and manage a plurality of documents; and
issue a print command regardless of a monochrome or a color through an application program which starts up a target document from among the stored documents.

20. A document management program according to claim 19, wherein the monochrome printing and the color printing are designated at the same time.
